(19) United States
(12) Patent Application Publication
(10) Pub. No.: US 2026/0311403 A1
(43) Pub. Date: Oct. 8, 2026

(54) INFORMATION PROCESSING APPARATUS AND INFORMATION PROCESSING METHOD

(71) Applicant: CANON KABUSHIKI KAISHA, Tokyo (JP)

(72) Inventors: MASARU OMATA, Tokyo (JP); HAYATO OURA, Tokyo (JP)

(21) Appl. No.: 19/565,759

(22) Filed: Mar. 13, 2026

(30) Foreign Application Priority Data
Apr. 8, 2025 (JP) 2025-063618

(51) Int. Cl. G06T 11/60; G06F 40/166; G06F 40/40; G06T 7/70; G06V 10/774; G06V 20/10

(52) U.S. Cl. CPC G06T 11/60; G06F 40/166; G06F 40/40; G06T 7/70; G06V 10/774; G06V 20/176; G06T 2207/20081; G06T 2207/30184; G06T 2207/30244

(57) ABSTRACT

An information processing apparatus includes: a processor; and a memory storing a program which, when executed by the processor, causes the information processing apparatus to: execute first acquisition processing of acquiring a captured image, position information indicating a capturing position where the captured image is captured, and direction information indicating a direction in which the captured image is captured from the capturing position; execute second acquisition processing of acquiring information on a proper name of an object present in the direction from the capturing position from map information on a basis of the position information and the direction information; and execute generation processing of generating a prompt, which is a text for instructing generation of an image imitating the captured image, on a basis of the captured image and the information on the proper name.

### BACKGROUND

### Field of the Technology

The present disclosure relates to an information processing apparatus and an information processing method.

### Description of the Related Art

In recent years, an image generation technology, such as DALL-E2 developed by OpenAI, has been developed. In such an image generation technology, an image is generated using a visual language model (VLM) and a diffusion model with a sentence called a prompt as an input. Japanese Patent Laid-Open No. 2022-018997 proposes that a result of image recognition processing performed by a trained deep neural network (DNN) using a RAW image as an input is output together with the RAW image subjected to various types of image processing.

When a captured RAW image is to be reproduced on the basis of information of a smaller data amount, it is difficult to reduce a data amount of output data in a case where a result of image recognition processing is output together with the RAW image. In addition, in a case where an image is generated by the VLM and the diffusion model using only the result of the image recognition processing of the RAW image as a prompt, there is a possibility that an image different from the original RAW image or an image not intended by a user is generated so that reproducibility of the original RAW image is deteriorated.

### SUMMARY

The present disclosure provides an information processing apparatus capable of reducing a data amount of information used to generate an image imitating a captured image and improving reproducibility of the captured image.

A information processing apparatus according to the present disclosure includes: a processor; and a memory storing a program which, when executed by the processor, causes the information processing apparatus to: execute first acquisition processing of acquiring a captured image, position information indicating a capturing position where the captured image is captured, and direction information indicating a direction in which the captured image is captured from the capturing position; execute second acquisition processing of acquiring information on a proper name of an object present in the direction from the capturing position from map information on a basis of the position information and the direction information; and execute generation processing of generating a prompt, which is a text for instructing generation of an image imitating the captured image, on a basis of the captured image and the information on the proper name.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an information processing apparatus.

FIG. 2 is a flowchart illustrating image generation processing according to a first embodiment.

FIG. 3 is a view for describing a method for acquiring information on a proper name from an image capturing situation.

FIGS. 4A to 4C are views for describing a method for generating a prompt using a proper name.

FIG. 5 is a flowchart illustrating image generation processing according to a second embodiment.

### DESCRIPTION OF THE EMBODIMENTS

### First Embodiment

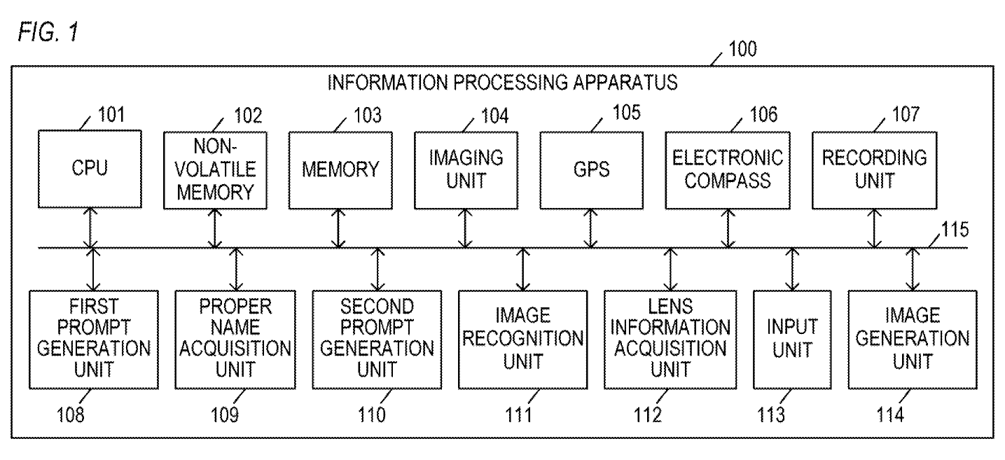

Hereinafter, embodiments of the present disclosure will be described with reference to the drawings. FIG. 1 is a block diagram illustrating a configuration of an information processing apparatus 100.

The information processing apparatus 100 includes a CPU 101, a non-volatile memory 102, a memory 103, an imaging unit 104, a GPS 105, an electronic compass 106, and a recording unit 107. The information processing apparatus 100 further includes a first prompt generation unit 108, a proper name acquisition unit 109, a second prompt generation unit 110, an image recognition unit 111, a lens information acquisition unit 112, an input unit 113, and an image generation unit 114. The units (functional blocks) included in the information processing apparatus 100 are mutually connected by a system bus 115. The information processing apparatus 100 is an electronic device such as a personal computer, a smartphone, a tablet terminal, or a camera.

The CPU 101 executes programs stored in the non-volatile memory 102 to control operations of the respective units of the information processing apparatus 100 via the system bus 115.

The non-volatile memory 102 is an electrically erasable and recordable non-volatile memory. The non-volatile memory 102 is, for example, a read-only memory (ROM), a hard disk, or the like. The non-volatile memory 102 stores various programs and the like for the CPU 101 to operate.

The memory 103 is a rewritable volatile memory. The memory 103 is, for example, a dynamic random-access memory (DRAM) or the like. The CPU 101 uses the memory 103 as a work memory for executing the programs stored in the non-volatile memory 102. The memory 103 is also used to temporarily store a captured image and various types of information acquired by the CPU 101.

The imaging unit 104 is an imaging device including a lens, a shutter having a diaphragm function, and a sensor, such as a CCD element or a CMOS element, which converts an optical image into an electric signal. The imaging unit 104 includes an image processing unit that performs various types of image processing, such as exposure control, on a signal obtained by imaging. Note that the imaging unit 104 may be an external imaging device different from the information processing apparatus 100. It is sufficient for the information processing apparatus 100 to be able to receive a captured image from the external imaging device.

The GPS 105 has a function of receiving a signal from an artificial satellite and calculating a current position. The electronic compass 106 is a device that measures an azimuth using a geomagnetic sensor, and has a function of detecting a geomagnetic field and measuring the azimuth of the information processing apparatus 100.

The recording unit 107 is, for example, a secure digital (SD) card, a compact flash (CF) card, a solid state-drive (SSD), or the like. The recording unit 107 is a recording area for storing data such as an image obtained by capturing.

The recording unit 107 records a trained model for prompt generation used by the first prompt generation unit 108, a trained model for image recognition used by the image recognition unit 111, a trained model for image generation used by the image generation unit 114, and the like. Each of the trained models is, for example, a trained model which uses a neural network. In addition, the recording unit 107 records map information used by the proper name acquisition unit 109. Note that various types of data, such as the respective trained models and the map information, may be acquired from the outside, and a method for recording the various types of data is not particularly limited.

The first prompt generation unit 108 reads, from the recording unit 107, the trained model for prompt generation recorded in the recording unit 107, and inputs a captured image. The trained model for prompt generation outputs a text indicating a feature of the input captured image. The first prompt generation unit 108 records the text, output from the trained model for prompt generation, in the memory 103 as a first prompt. The first prompt generation unit 108 may generate the first prompt from the captured image using a known technique such as neural network operation processing performed by the trained model for prompt generation and generative AI.

The proper name acquisition unit 109 can acquire information on a proper name of a specific point on a map using a point of interest (POI). The proper name acquisition unit 109 can acquire information on the proper name from the map information recorded in the recording unit 107 on the basis of position information indicating a capturing position at which the captured image is captured and direction information indicating a direction in which the captured image is captured from the capturing position.

The position information indicating the capturing position at which the captured image is captured is acquired by the GPS 105 at the time of image capturing by the imaging unit 104. The direction information indicating the direction in which the captured image is captured from the capturing position is acquired by the electronic compass 106 at the time of image capturing by imaging unit 104.

In a case where the captured image is an image captured by an external imaging device, the position information and the direction information can be acquired from metadata of the captured image. In addition, the proper name acquisition unit 109 may transmit the position information and the direction information at the time of capturing the captured image to an external server or the like, and acquire the information on the proper name from the server.

The second prompt generation unit 110 generates a second prompt on the basis of the first prompt generated by the first prompt generation unit 108 and the information on the proper name acquired by the proper name acquisition unit 109. Since the second prompt is generated on the basis of the proper name, the captured image can be generated more accurately than the first prompt.

The image recognition unit 111 detects an object appearing in the image using the trained model for image recognition which uses a neural network and is recorded in the recording unit 107. The image recognition unit 111 can detect the object corresponding to a predetermined proper name. For example, the image recognition unit 111 can detect the object corresponding to the predetermined proper name from the captured image by pattern matching with an image prepared in advance for the object corresponding to the proper name.

The lens information acquisition unit 112 acquires information of a lens included in the imaging unit 104. The input unit 113 includes a display, such as a monitor, which prompts a user to input an instruction, and operation members, such as a mouse and a touch panel, for the input of the instruction from the user.

The image generation unit 114 generates an image by inference processing of the trained model for image generation, which uses a neural network, with a prompt as an input. An image generation method is not limited thereto, and the image generation unit 114 may generate an image using a known technique such as image generative AI on the basis of instruction content of the prompt. The image generation unit 114 records the generated image in the recording unit 107.

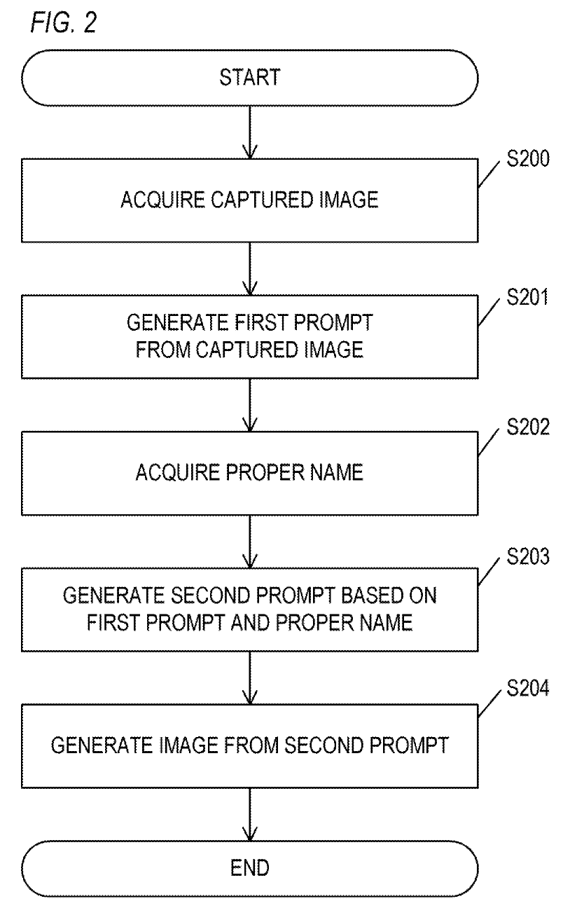

Image generation processing according to the first embodiment will be described with reference to FIG. 2. The information processing apparatus 100 generates a prompt (the second prompt) that is a text for instructing generation of an image imitating a captured image on the basis of the captured image and the information on the proper name of the object appearing in the captured image. In the example of FIG. 2, the information processing apparatus 100 generates the first prompt that is a text for instructing generation of an image imitating the captured image on the basis of the captured image, and generates the second prompt on the basis of instruction content of the first prompt and the information on the proper name of the object.

The trained model for prompt generation used by the first prompt generation unit 108, the trained model for image recognition used by the image recognition unit 111, and the trained model for image generation used by the image generation unit 114 are recorded in advance in the recording unit 107. In addition, the map information used by the proper name acquisition unit 109 is recorded in the recording unit 107 in advance.

In step S200, the imaging unit 104 receives a user operation from the input unit 113, starts an image capturing operation, and acquires a captured image. The imaging unit 104 temporarily records the acquired captured image in the memory 103. The GPS 105 acquires position information indicating a capturing position at which the captured image is captured. The GPS 105 records the acquired position information in the memory 103. The electronic compass 106 acquires direction information indicating a direction (hereinafter, also described as a capturing direction) in which the captured image is captured from the capturing position. The electronic compass 106 records the acquired direction information in the memory 103.

In step S201, the first prompt generation unit 108 generates a first prompt from the captured image acquired in step S200. First, the first prompt generation unit 108 reads the captured image and the trained model for prompt generation from the memory 103.

Next, the first prompt generation unit 108 inputs the captured image to the trained model for prompt generation, and generates the first prompt indicating a feature of the captured image by neural network operation processing. The trained model for prompt generation is a trained model that has been trained to output a training prompt that is a text that enables generation of an image imitating a training image with the training image as an input. The first prompt is a text for instructing generation of an image imitating the captured image. The first prompt generation unit 108 records the generated first prompt in the memory 103.

In step S202, the proper name acquisition unit 109 acquires information on a proper name of an object present in the direction in which the captured image is captured from the capturing position. First, the proper name acquisition unit 109 reads the position information and the direction information recorded in the memory 103 in step S200. In addition, the proper name acquisition unit 109 reads map information recorded in advance in the recording unit 107.

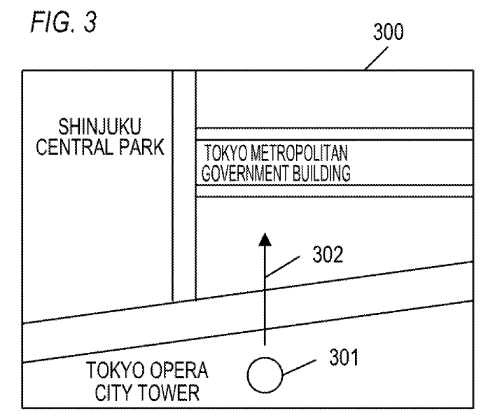

Next, the proper name acquisition unit 109 acquires the information on the proper name of the object present in the capturing direction from the capturing position from the map information on the basis of the read position information and the read direction information. The proper name acquisition unit 109 records the acquired information on the proper name in the memory 103. Details of processing of acquiring the information on the proper name will be described later with reference to FIG. 3.

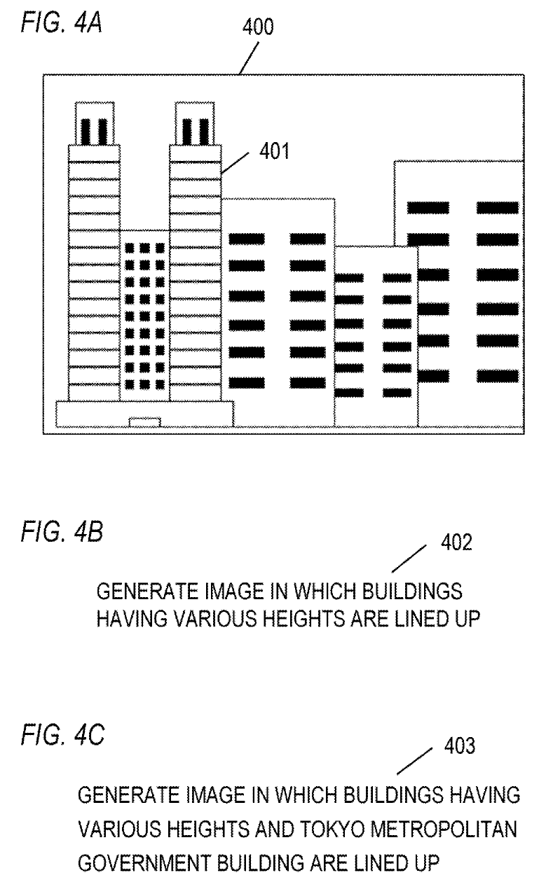

In step S203, the second prompt generation unit 110 generates a second prompt on the basis of the first prompt and the proper name. First, the second prompt generation unit 110 reads the first prompt and the proper name from the memory 103. Then, the second prompt generation unit 110 generates the second prompt on the basis of instruction content of the first prompt and the information on the proper name. The second prompt generation unit 110 records the generated second prompt in the memory 103. Details of second prompt generation processing will be described later with reference to FIGS. 4A to 4C.

In step S204, the image generation unit 114 generates an image based on instruction content of the second prompt. First, the image generation unit 114 reads the second prompt and the trained model for image generation from the memory 103.

Next, the image generation unit 114 inputs the second prompt to a trained model for image generation, and generates an image imitating the captured image. The trained model for image generation is a trained model trained to output a training image generated on the basis of instruction content of a training prompt with the training prompt as an input.

The second prompt includes the information on the proper name of the object appearing in the captured image, and thus can improve reproducibility of the captured image more than the first prompt. In addition, in a case where it is desired to reproduce the captured image by an external device, the external device can accurately reproduce the captured image by receiving the second prompt that is text data without receiving the captured image. Therefore, the amount of data transmitted to reproduce the captured image by the external device can be reduced.

The processing of acquiring the information on the proper name described in step S202 will be described with reference to FIG. 3. FIG. 3 illustrates a situation at the time of image capturing by the imaging unit 104. Map information 300 includes, as proper names, the Tokyo Metropolitan Government Building, Shinjuku Central Park, and Tokyo Opera City Tower.

The imaging unit 104 captures an image in a direction indicated by a capturing direction 302 from a capturing position 301. The capturing position 301 is acquired by the GPS 105. The capturing direction 302 is acquired by the electronic compass 106.

The proper name acquisition unit 109 acquires, from the map information 300, information on Shinjuku Central Park and the Tokyo Metropolitan Government Building, which are objects present in the capturing direction 302 from the capturing position 301, as information on proper names of objects that can be included in the captured image. The proper name acquisition unit 109 records the acquired information on the proper name in the memory 103. The proper name acquisition unit 109 does not acquire information on Tokyo Opera City Tower that is not present in the capturing direction 302 since Tokyo Opera City Tower is not included in the captured image.

When the proper name acquisition unit 109 acquires the information on the proper names of the objects that can be included in the captured image, the image recognition unit 111 confirms whether the objects corresponding to the proper names appear in the captured image.

First, the image recognition unit 111 reads the captured image and the trained model for image recognition from the memory 103. Next, the image recognition unit 111 inputs the captured image to the trained model for image recognition, and performs image recognition processing of detecting the object corresponding to the proper name from the captured image by neural network operation processing.

In a case where the object corresponding to the proper name is not detected, the second prompt generation unit 110 generates the second prompt without using the information on the proper name. For example, in the example of FIG. 3, when the image recognition unit 111 detects images of buildings from the captured image and does not detect an image of a park, the second prompt generation unit 110 uses only the information on the Tokyo Metropolitan Government Building as the information on the proper name. That is, the second prompt generation unit 110 generates the second prompt without using the information on Shinjuku Central Park.

In a case where the captured image is an image captured using a microlens, the proper name acquisition unit 109 does not necessarily acquire information on a proper name. This is because it is assumed that the image captured using the microlens does not capture any object corresponding to the proper name. For example, the lens information acquisition unit 112 can acquire lens information before executing step S202 and determine whether the lens used for image capturing is the microlens. When the captured image is the image captured using the microlens, the processing of step S202 is omitted.

In addition, the lens information acquisition unit 112 may acquire the lens information before executing step S203. When the captured image is the image captured using the microlens, the second prompt generation unit 110 generates the second prompt without using the information on the proper name obtained in step S202.

The second prompt generation processing described in step S203 will be described with reference to FIGS. 4A to 4C. FIG. 4A illustrates a captured image 400 captured in the capturing direction 302 from the capturing position 301 illustrated in FIG. 3. The Tokyo Metropolitan Government Building 401 appears in the captured image 400. FIG. 4B is an example of a first prompt 402 generated by the first prompt generation unit 108.

The second prompt generation unit 110 reads the information on the proper name generated by the proper name acquisition unit 109 and the first prompt 402 generated by the first prompt generation unit 108 from the memory 103. In the example of FIG. 4A, the proper name is the Tokyo Metropolitan Government Building. The second prompt generation unit 110 generates a second prompt 403 on the basis of the instruction content of the first prompt 402 and the information on the proper name.

FIG. 4C is an example of the second prompt 403 generated by the second prompt generation unit 110. The second prompt generation unit 110 may generate the second prompt 403 by incorporating the information on the proper name into a text of the first prompt 402. In the example of FIG. 4C, the proper name of “Tokyo Metropolitan Government Building” is incorporated into the text of the first prompt 402. In addition, the second prompt generation unit 110 may generate the second prompt by replacing a common name of an object having a proper name with the proper name in the first prompt.

According to the first embodiment, the information processing apparatus 100 generates the second prompt for instructing the generation of the image imitating the captured image using the information on the proper name of the object appearing in the captured image. Therefore, the information processing apparatus 100 can improve the reproducibility when generating the image imitating the captured image. In addition, the information processing apparatus 100 can display the captured image with higher reproducibility on an external device, without transmitting the captured image, by transmitting the second prompt for displaying the captured image on the external device. Therefore, when the captured image acquired by the information processing apparatus 100 is displayed on the external device, the information processing apparatus 100 can reduce the amount of data to be transmitted to the external device. That is, the information processing apparatus 100 can reduce a data amount of information used to generate the image imitating the captured image and improve the reproducibility of the captured image.

### Second Embodiment

In the first embodiment, the information processing apparatus 100 generates the second prompt on the basis of the instruction content of the first prompt generated from the captured image and the information on the proper name of the object appearing in the captured image, and generates the image imitating the captured image from the generated second prompt. On the other hand, in a second embodiment, the information processing apparatus 100 generates an image imitating a captured image on the basis of a first prompt and information on a proper name.

A configuration of the information processing apparatus 100 according to the second embodiment is substantially similar to the configuration of the information processing apparatus 100 according to the first embodiment described with reference to FIG. 1. The information processing apparatus 100 according to the second embodiment does not necessarily include the second prompt generation unit 110. In addition, processing of the image generation unit 114 according to the second embodiment is different from the processing of the image generation unit 114 according to the first embodiment.

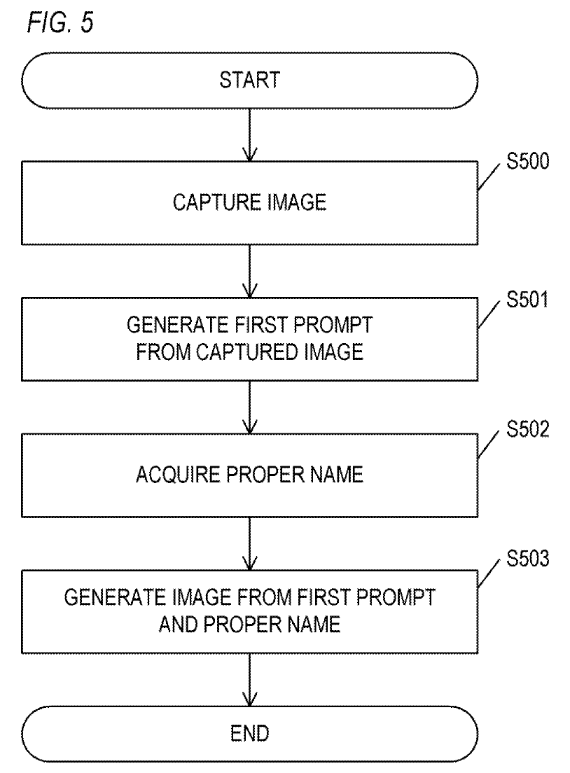

Image generation processing according to the second embodiment will be described with reference to FIG. 5. The processing illustrated in FIG. 5 is processing of generating the image imitating the captured image on the basis of the first prompt generated from the captured image and the information on the proper name of an object appearing in the captured image. A trained model for image generation used by the image generation unit 114 is recorded in the recording unit 107 in advance.

Since the processing of steps S500 to S502 is the same as the processing of steps S200 to S202 of FIG. 2, description thereof will be omitted.

In step S503, the image generation unit 114 generates an image imitating a captured image on the basis of a first prompt and information on a proper name. First, the image generation unit 114 reads the first prompt and the information on the proper name from the memory 103.

In addition, the image generation unit 114 reads a trained model for image generation recorded in the recording unit 107. The trained model for image generation according to the second embodiment is a trained model trained to output a training prompt, which is a text that enables generation of an image imitating a training image, with the training image and information on a proper name corresponding to an object appearing in the training image as inputs.

Next, the image generation unit 114 can generate the image imitating the captured image by inputting the first prompt and the information on the proper name to the trained model for image generation.

According to the second embodiment described above, the information processing apparatus 100 generates the image by using the information on the proper name of the object appearing in the captured image, and thus, can improve reproducibility when generating the image imitating the captured image. In addition, the information processing apparatus 100 can display the captured image with higher reproducibility on an external device, without transmitting the captured image, by transmitting the first prompt and the information on the proper name for displaying the captured image on the external device. Therefore, when the captured image acquired by the information processing apparatus 100 is displayed on the external device, the information processing apparatus 100 can reduce the amount of data to be transmitted to the external device. That is, the information processing apparatus 100 can reduce a data amount of information used to generate the image imitating the captured image and improve the reproducibility of the captured image.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to reduce a data amount of information used to generate an image imitating a captured image and improve reproducibility of the captured image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063618, filed April 8, 2025, which is hereby incorporated by reference herein in its entirety.

What is claimed is:

1. An information processing apparatus comprising:
a processor; and
a memory storing a program which, when executed by the processor, causes the information processing apparatus to:
execute first acquisition processing of acquiring a captured image, position information indicating a capturing position where the captured image is captured, and direction information indicating a direction in which the captured image is captured from the capturing position;
execute second acquisition processing of acquiring information on a proper name of an object present in the direction from the capturing position from map information on a basis of the position information and the direction information; and
execute generation processing of generating a prompt, which is a text for instructing generation of an image imitating the captured image, on a basis of the captured image and the information on the proper name.

2. The information processing apparatus according to claim 1, wherein
in the generation processing, a first prompt that is a text for instructing generation of an image imitating the captured image is generated on a basis of the captured image, and a second prompt that is the prompt is generated on a basis of instruction content of the first prompt and the information on the proper name.

3. The information processing apparatus according to claim 2, wherein
in the generation processing, the first prompt is generated using a trained model trained to output a training prompt, which is a text that enables generation of an image imitating a training image, with the training image as an input.

4. The information processing apparatus according to claim 2, wherein
in the generation processing, the second prompt is generated by incorporating the information on the proper name into a text of the first prompt.

5. The information processing apparatus according to claim 2, wherein
in the generation processing, the second prompt is generated by replacing a common name of an object having the proper name in the first prompt with the proper name.

6. The information processing apparatus according to claim 1, wherein the program, when executed by the processor, further causes the information processing apparatus to execute detection processing of detecting an object corresponding to the proper name from the captured image, and
in the generation processing, the prompt is generated without using the information on the proper name in a case where the object corresponding to the proper name is not detected from the captured image.

7. The information processing apparatus according to claim 1, wherein
in the second acquisition processing, the information on the proper name is not acquired in a case where the captured image is an image captured using a microlens.

8. The information processing apparatus according to claim 1, wherein the program, when executed by the processor, further causes the information processing apparatus to execute image generation processing of generating an image based on instruction content of the prompt.

9. The information processing apparatus according to claim 8, wherein
in the image generation processing, the image based on instruction content of the prompt is generated using a trained model trained to output a training image, generated on a basis of instruction content of a training prompt, with the training prompt as an input.

10. An information processing apparatus comprising:
a processor; and
a memory storing a program which, when executed by the processor, causes information processing apparatus to:
execute first acquisition processing of acquiring a captured image, position information indicating a capturing position where the captured image is captured, and direction information indicating a direction in which the captured image is captured from the capturing position;
execute second acquisition processing of acquiring information on a proper name of an object present in the direction from the capturing position from map information on a basis of the position information and the direction information;
execute generation processing of generating a prompt, which is a text for instructing generation of an image imitating the captured image, on a basis of the captured image; and
execute image generation processing of generating an image imitating the captured image on a basis of the information on the proper name and the prompt.

11. The information processing apparatus according to claim 10, wherein
in the generation processing, the prompt is generated using a trained model trained to output a training prompt, which is a text that enables generation of an image imitating a training image, with the training image and information on the proper name corresponding to an object appearing in the training image as inputs.

12. An information processing method comprising:
acquiring a captured image, position information indicating a capturing position where the captured image is captured, and direction information indicating a direction in which the captured image is captured from the capturing position;
acquiring information on a proper name of an object present in the direction from the capturing position from map information on a basis of the position information and the direction information; and
generating a prompt, which is a text for instructing generation of an image imitating the captured image, on a basis of the captured image and the information on the proper name.

13. An information processing method comprising:
acquiring a captured image, position information indicating a capturing position where the captured image is captured, and direction information indicating a direction in which the captured image is captured from the capturing position;
acquiring information on a proper name of an object present in the direction from the capturing position from map information on a basis of the position information and the direction information;
generating a prompt, which is a text for instructing generation of an image imitating the captured image, on a basis of the captured image; and
generating an image imitating the captured image on a basis of the information on the proper name and the prompt.

14. A non-transitory computer readable medium that stores a program, wherein the program causes a computer to execute an information processing method comprising:
acquiring a captured image, position information indicating a capturing position where the captured image is captured, and direction information indicating a direction in which the captured image is captured from the capturing position;
acquiring information on a proper name of an object present in the direction from the capturing position from map information on a basis of the position information and the direction information; and
generating a prompt, which is a text for instructing generation of an image imitating the captured image, on a basis of the captured image and the information on the proper name.

15. A non-transitory computer readable medium that stores a program, wherein the program causes a computer to execute an information processing method comprising:
acquiring a captured image, position information indicating a capturing position where the captured image is captured, and direction information indicating a direction in which the captured image is captured from the capturing position;
acquiring information on a proper name of an object present in the direction from the capturing position from map information on a basis of the position information and the direction information;
generating a prompt, which is a text for instructing generation of an image imitating the captured image, on a basis of the captured image; and
generating an image imitating the captured image on a basis of the information on the proper name and the prompt.
